(19) United States
(12) Patent Application Publication
(10) Pub. No.: US 2014/0307231 A1
(43) Pub. Date: Oct. 16, 2014

(54) LASER PROJECTION DEVICE

(71) Applicant: HON HAI PRECISION INDUSTRY CO., LTD., New Taipei (TW)

(72) Inventor: KAI-WEN WU, New Taipei (TW)

(73) Assignee: HON HAI PRECISION INDUSTRY CO., LTD., New Taipei (TW)

(21) Appl. No.: 13/893,356

(22) Filed: May 14, 2013

(30) Foreign Application Priority Data
Apr. 16, 2013 (TW) 102113381

(51) Int. Cl. G03B 21/20

(52) U.S. Cl. CPC G03B 21/2013
USPC 353/31

(57) ABSTRACT

A laser projection device includes a substrate, three laser diodes mounted on the substrate, and a spectroscope located on light paths of the laser diodes. The laser diodes are arranged along an arc-shaped curve. A sector-shaped region is defined by the three laser diodes and two intersected sides of the substrate. The spectroscope is located at the sector-shaped region. Light emitted from the laser diodes is adjusted by the spectroscope to transmit along a common direction and be mixed with each other.

### BACKGROUND

1. Technical Field

The disclosure generally relates to projection devices and more particularly to a laser projection device.

2. Description of Related Art

Laser projection devices are more and more popular for its projected images having a lager color gamut, a higher brightness, an increased contrast and a better saturation.

Referring to FIG. 1, a conventional laser projection device 100 includes a substrate 10, a plurality of light emitting diodes (LEDs) 21, 23, 25 mounted on a top surface of the substrate 10, and a plurality of beam splitters 31, 33, 35 located on light paths of the LEDs 21, 23, 25 respectively. The LEDs 21, 23, 25 are spaced from each other, and are arranged in a line along a longitudinal direction of the substrate 10. The beam splitters 31, 33, 35 are spaced from each other, and are arranged in a line along a longitudinal direction of the substrate 10. Each beam splitter 31 (33, 35) is aligned with each LED 21 (23, 25), respectively. Light emitted from the LEDs 21, 23, 25 radiates to the beam splitters 31, 33, 35, and then is adjusted by each corresponding beam splitters 31 33, 35 to be oriented toward a same direction and mixed together.

However, the distribution of the LEDs 21, 23, 25 and the beam splitters 31, 33, 35 in FIG. 1 causes that a size of the substrate 10 is required larger relative to a conventional laser projection device 100, resulting in the bulk of the laser projection device 100 increased.

What is needed, therefore, is an improved laser projection device which can overcome the above described shortcomings

### BRIEF DESCRIPTION OF THE DRAWINGS

FIG. 1 is a schematic view showing a conventional laser projection device.

FIG. 2 is a schematic view showing a laser projection device according to an exemplary embodiment of the present disclosure.

FIG. 3 is a schematic view showing light paths of the laser projection device of FIG. 2.

### DETAILED DESCRIPTION

Embodiment of laser projection device will now be described in detail below and with reference to the drawings.

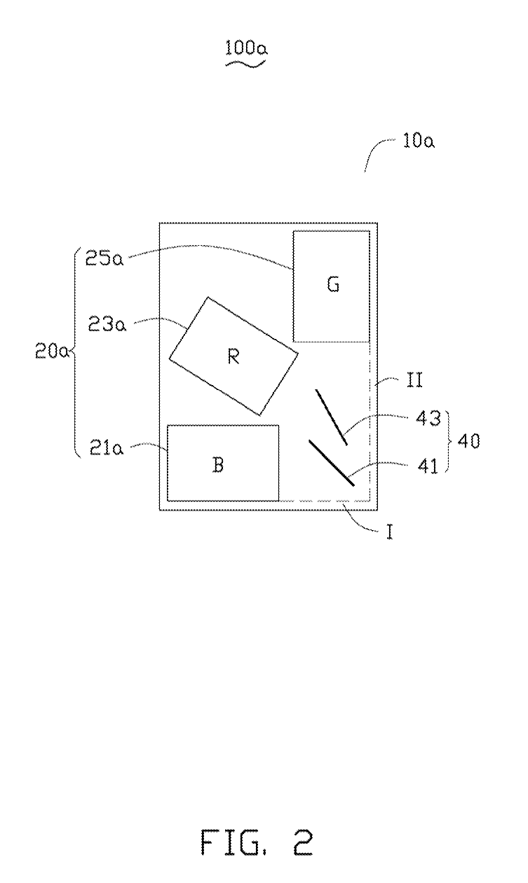

Referring to FIG. 2, a laser projection device 100a according to an exemplary embodiment of the present disclosure includes a substrate 10a, a light source 20a, and a spectroscope 40. The light source 20a and the spectroscope 40 are mounted on the substrate 10a. The spectroscope 40 is arranged on light paths of light emitted from the light source 20a.

The substrate 10a is flat. The light source 20a and the spectroscope 40 are arranged on a top surface of the substrate 10a. A circuit (not shown) is arranged on the top surface of the substrate 10a. In this embodiment, the substrate 10 is made of electrically insulating materials, such as silicone, epoxy.

The light source 20a includes a first laser chip 21a, a second laser chip 23a and a third laser chip 25a. Each laser chip 21a (23a, 25a) is a laser diode. A brightness of each laser chip 21a (23a, 25a) can be controlled by a current flow through the circuit. The light source 20a is used to emit laser beams with colors needed.

The laser chips 21a, 23a, 25a are arranged on the substrate 10a along an arc-shaped curve. A sector-shaped region is defined by the laser chips 21a, 23a, 25a and two adjacent sides of the substrate 10a.

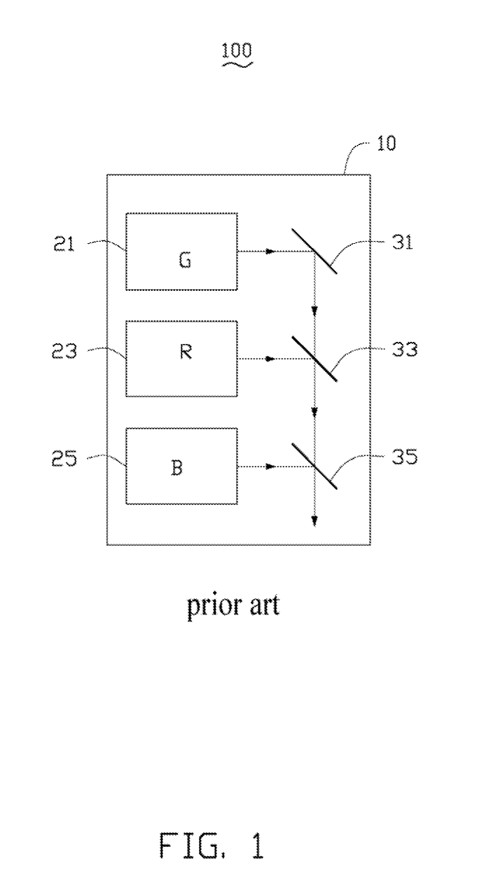

In this embodiment, the first laser chip 21a is arranged approaching, and is facing toward a corner of the top surface of the substrate 10a, and light emitting direction of the first laser chip 21a is along a transverse direction of the substrate 10a (shown in FIG. 1). The third laser chip 25a is also arranged approaching, and is facing toward the corner, and light emitting direction of the third laser chip 25a is along a longitudinal direction of the substrate 10a (shown in FIG. 1). The second laser chip 23a is arranged approaching, and is facing toward the corner, and is slantwise between the first laser chip 21a and the third laser chip 23a.

The light emitting directions of the laser chips 21a, 23a and 25a are intersected. A sharp angle is defined between the light emitting direction of the second laser chip 23a and the transverse direction of the substrate 10a. Alternatively, the located positions of the laser chips 21a, 23a and 25a can be exchanged.

The spectroscope 40 is in the sector-shaped region, and light emitted from the laser chips 21a, 23a and 25a is adjusted to be oriented to a same direction to mix together.

The spectroscope 40 includes a first beam splitter 41, and a second beam splitter 43 spaced from the first beam splitter 41. The first beam splitter 41 and the second beam splitter 43 are arranged slantwise on the top surface of the substrate 10a. A sharp angle is defined between the first beam splitter 41 and the second beam splitter 43. In detail, the first beam splitter 41 and the second beam splitter 43 are located in a region surrounded by a dashed line I extending from an outer side of the first laser chip 21a, another dashed line II extending from an outer side of the third laser chip 25a, and the arranged curve of the laser chips 21a, 23a and 25a.

The first beam splitter 41 is located on light paths of the first laser chip 21a, the second beam splitter 43 is located on light paths of the second laser chip 23a. Both of the first beam splitter 41 and the second beam splitter 43 are located on light paths of the third laser chip 25a. The beam splitters 41, 43 are used to adjust light emitted from the laser chips 21a, 23a and 25a to mix together. The beam splitters 41, 43 are located at the sector-shaped region of the substrate 10a.

In this embodiment, the first laser chip 21a is a blue laser diode, the second laser chip 23a is a red laser diode, the third laser chip 25a is a green laser diode, and the first beam splitter 41 is a blue beam splitter, the second beam splitter 43 is a red beam splitter.

The first beam splitter 41 may reflect the blue laser beams and laser beams whose wavelength is near the wavelength of blue laser beams, but allows laser beams with other wavelength to pass through; the second beam splitter 43 may reflect the red laser beams and laser beams whose wavelength is near the wavelength of red laser beams, but allows laser beams with other wavelength to pass through.

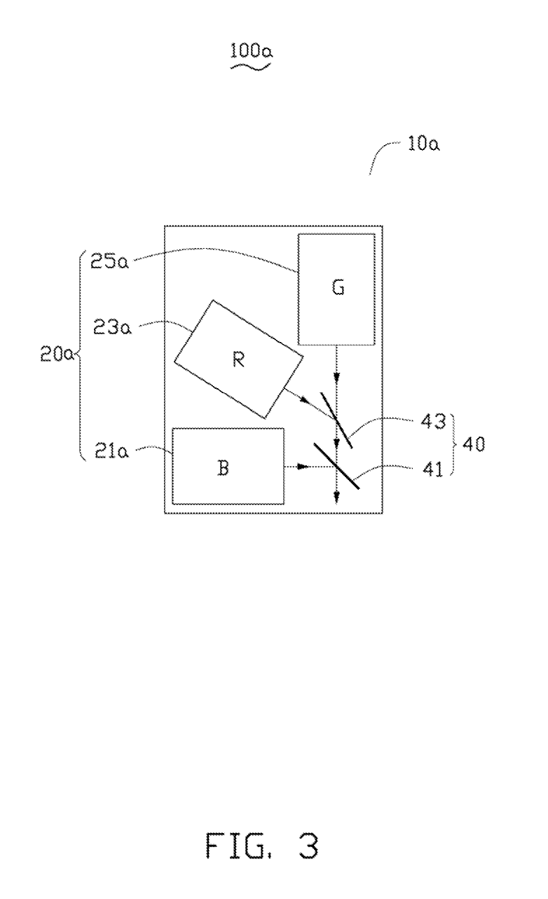

Referring to FIG. 3, when the laser projection device 100a works, the blue laser beams emitted from the first laser chip 21a are reflected by the corresponding first beam splitter 41 to emit out from a side of the substrate 10a; the red laser beams emitted from the second laser chip 23a are reflected by the corresponding second beam splitter 43 to pass through the first beam splitter 41, and to emit out in a same direction with the blue laser beams; the green laser beams emitted from the third laser chip 25a passes through the beam splitters 43, 41 sequentially to mix with the blue laser beams and red laser beams to obtain light of a predetermined color which usually is white. Alternatively, the located positions of the beam splitters 41, 43 can be exchanged correspondingly, according the located positions of the laser chips 21a, 23a and 25a.

According to the laser projection device 100a of the present disclosure, because the laser chips 21a, 23a and 25a are arranged in a arc-shaped curve, and the first beam splitter 41 and the second beam splitter 43 are in the region surrounded by a dashed line I extending from an outer side of the first laser chip 21a, another dashed line II extending from an outer side of the third laser chip 25a, and the arranged curve of the laser chips 21a, 23a, 25a, the occupied areas of the substrate 10a are reduced, whereby the bulk of the substrate 10a can be smaller. As such, the bulk of the laser projection device 100a can be reduced.

Otherwise, in this disclosure, only two beam splitters 41, 43 are needed to adjust light emitted from the laser chips 21a, 23a and 25a to mix together, whereby the bulk and the cost of manufacturing the laser projection device 100a are reduced.

It is to be further understood that even though numerous characteristics and advantages of the present embodiment have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A laser projection device comprising:
a substrate;
a first laser chip, a second laser chip and a third laser chip mounted on the substrate, each laser chip being a laser diode; and
a spectroscope arranged on laser beams paths of the laser chips;
wherein the laser chips being arranged along a arc-shaped curve, and a sector-shaped region being defined by the arc-shaped curve and two adjacent sides of the substrate, the spectroscope being located in the sector-shaped region, beams emitted from the laser chips being adjust by the spectroscope to be oriented to a same direction to mix together.

2. The laser projection device of claim 1, wherein the spectroscope includes a first beam splitter and a second beam splitter spaced from the first beam splitter, and the first beam splitter and the second beam splitter are located at the sector-shaped region.

3. The laser projection device of claim 2, wherein a sharp angle is defined by the first beam splitter and the second beam splitter.

4. The laser projection device of claim 2, wherein the first beam splitter is on light paths of the first laser chip, the second beam splitter is on light paths of the second beam splitter, and the first beam splitter and the second beam splitter are on light paths of the third laser chip.

5. The laser projection device of claim 4, wherein the three laser chips are approaching and facing toward a corner of the top surface of the substrate, the first laser chip is arranged along a transverse direction of the substrate, the third laser chip is arranged along a longitudinal direction of the substrate, and the second laser chip is arranged slantwise between the first laser chip and the third laser chip.

6. The laser projection device of claim 5, wherein a sharp angle is defined between light emitting direction of the second laser chip and the transverse direction of the substrate.

7. The laser projection device of claim 4, wherein the laser beams emitted from the first laser chip are reflected by the first beam splitter to emit out, the laser beams emitted from the second laser chip are reflected by the second beam splitter to pass through the first beam splitter, and the laser beams emitted from the third laser chip pass through the second beam splitter and the first beam splitter to mix other laser beams emitted from the first laser chip and the second laser chip.

8. The laser projection device of claim 1, wherein the first laser chip is a blue laser diode, the second laser chip is a red laser diode, and the third laser chip is a green laser diode.

9. The laser projection device of claim 8, wherein the first beam splitter is a blue beam splitter, and the second beam splitter is a red beam splitter.

10. The laser projection device of claim 1, wherein the laser chips are spaced from each other.
